(19) United States
(12) Patent Application Publication
(10) Pub. No.: US 2024/0408747 A1
(43) Pub. Date: Dec. 12, 2024

(54) ROBOT ARM

(71) Applicant: SEIKO EPSON CORPORATION, Tokyo (JP)

(72) Inventor: Daichi TAKAHARA, MATSUMOTO-SHI (JP)

(21) Appl. No.: 18/736,600

(22) Filed: Jun. 7, 2024

(30) Foreign Application Priority Data
Jun. 9, 2023 (JP) 2023-095364

(51) Int. Cl. B25J 9/10

(52) U.S. Cl. CPC B25J 9/102; B25J 9/108

(57) ABSTRACT

A robot arm includes a first arm having a first insertion hole and a second insertion hole that communicate with each other inside, a bearing case inserted into the first insertion hole, a first gear passed through the bearing case and inserted into the first insertion hole, a first bearing and a second bearing located apart from each other along the first rotation axis in the bearing case, as the first bearing and the second bearing rotatably supports the first gear about the first rotation axis so as to the first arm, and a second gear that is inserted into the second insertion hole and meshes with the first gear in the first arm.

### CROSS-REFERENCE TO RELATED APPLICATIONS

The present application is based on, and claims priority from JP Application Serial Number 2023-095364, filed Jun. 9, 2023, the disclosure of which is hereby incorporated by reference herein in its entirety.

### BACKGROUND OF THE INVENTION

### 1. Technical Field

The present disclosure relates to a robot arm.

### 2. Related Art

JP-A-2022-070647 discloses a six axes vertical articulated robot including a base and a robot arm coupled to the base. The robot arm includes a shoulder section rotatably coupled to the base about a first rotation axis, a lower arm rotatably coupled to the shoulder section about a second rotation axis, a first upper arm rotatably coupled to the lower arm about a third rotation axis, a second upper arm rotatably coupled to the first upper arm about a fourth rotation axis, a wrist section rotatably coupled to the second upper arm about a fifth rotation axis, and a flange rotatably coupled to the wrist section about a sixth rotation axis.

In addition, the wrist section houses an input bevel gear that rotates around the fifth rotation axis and an output bevel gear that meshes with the input bevel gear and rotates around the sixth rotation axis. The input bevel gear and the output bevel gear are respectively born by the wrist section via bearings.

However, in the vertical articulated robot having such a configuration, when the input bevel gear is moved along the fifth rotation axis in order to perform the tooth contact adjustment with the output bevel gear, the bearing may be displaced or may come into contact with the input bevel gear or the second upper arm, and may be broken or damaged.

### SUMMARY OF THE INVENTION

A robot arm according to the present disclosure includes
a first arm including a first insertion hole and a second insertion hole that internally communicate with each other,
a bearing case inserted into the first insertion hole, a first gear passed through the bearing case and inserted into the first insertion hole,
a first bearing and a second bearing that are disposed inside the bearing case, that support so that the first gear rotates around a first rotation axis with respect to the first arm, and that are disposed separated from each other along the first rotation axis, and
a second gear that is inserted into the second insertion hole and that meshes with the first gear in the first arm.

### BRIEF DESCRIPTION OF DRAWINGS

FIG. 1 is a diagram showing an overall configuration of a robot system according to a preferred embodiment.

FIG. 2 is a cross-sectional view showing the inside of the arm.

FIG. 3 is a cross-sectional view showing the inside of the arm.

FIG. 4 is a cross-sectional view showing a state where the input bevel gear unit is removed from the arm.

### DETAILED DESCRIPTION OF THE INVENTION

Hereinafter, preferred embodiments of a robot arm will be described with reference to the accompanying drawings.

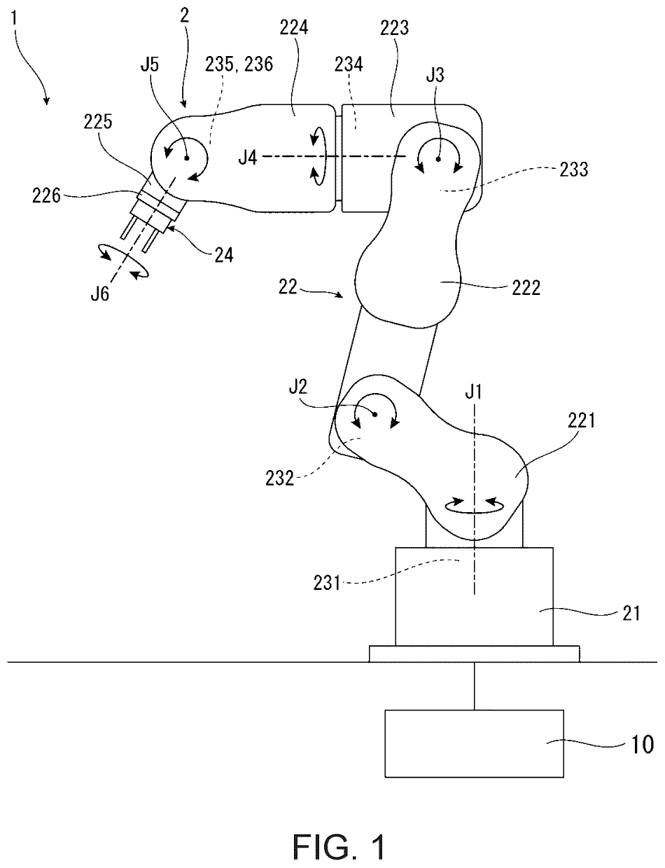

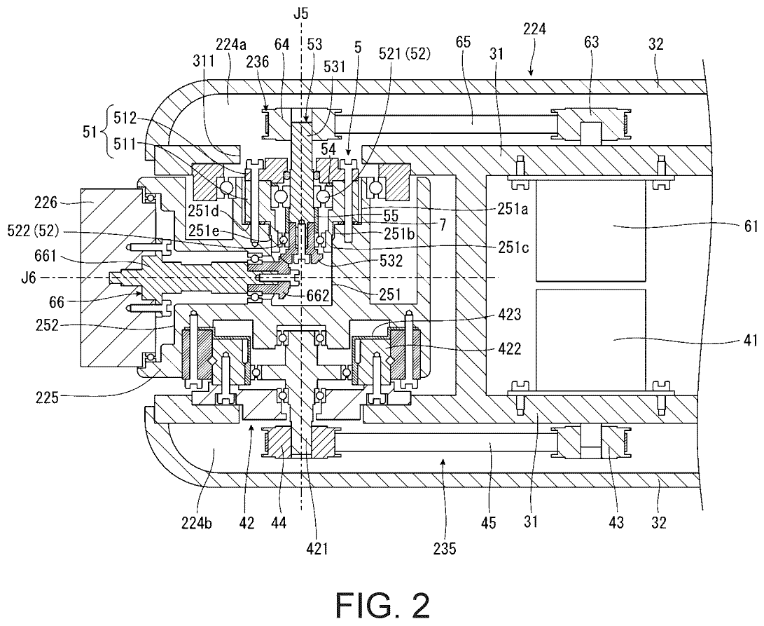

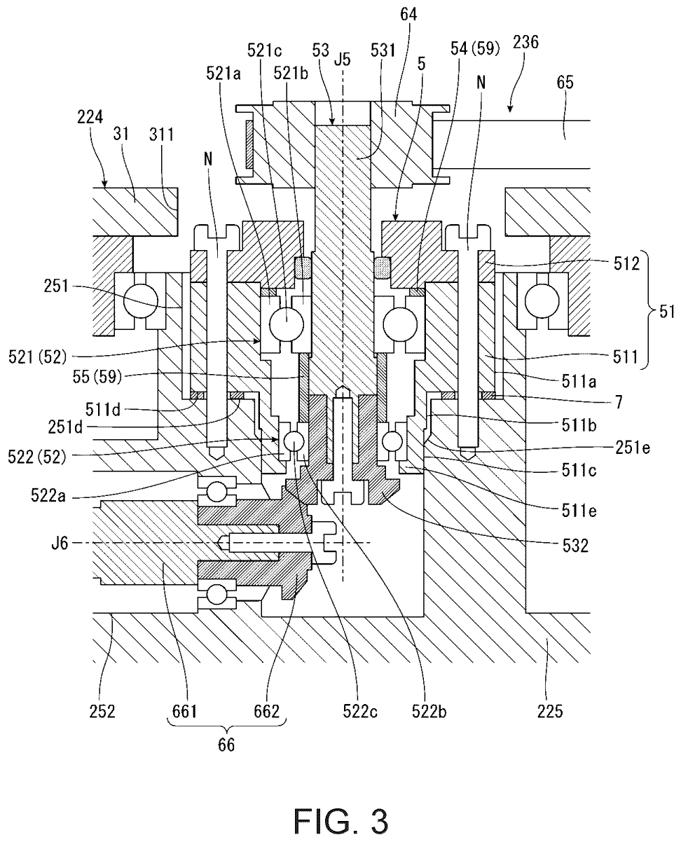

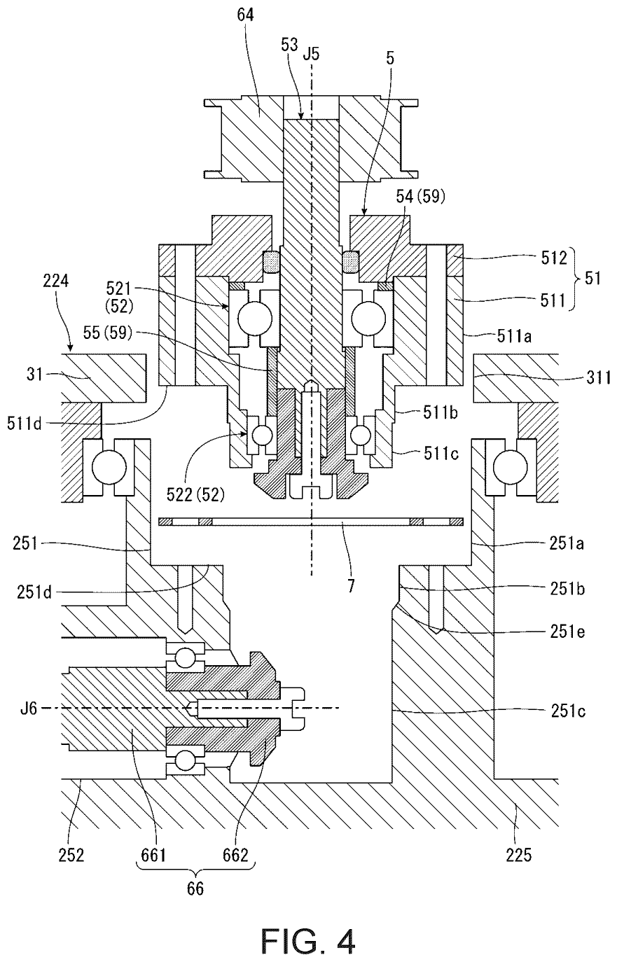

FIG. 1 is a diagram showing an overall configuration of a robot system according to a preferred embodiment. FIG. 2 is a cross-sectional view showing the inside of the arm. FIG. 3 is a cross-sectional view showing the inside of the arm. FIG. 4 is a cross-sectional view showing a state where the input bevel gear unit is removed from the arm.

A robot system 1 illustrated in FIG. 1 includes a robot 2 and a robot controller 10 that controls driving of the robot 2.

The robot 2 is a vertical articulated robot having six drive axes. The robot 2 includes a base 21 fixed to a floor and a robot arm 22 coupled to the base 21.

The robot arm 22 includes an arm 221 that is coupled to the base 21 and that rotates around the rotation axis J1 with respect to the base 21, an arm 222 that is coupled to the arm 221 and that rotates around the rotation axis J2 with respect to the arm 221, an arm 223 that is coupled to the arm 222 and that rotates around the rotation axis J3 with respect to the arm 222, an arm 224 as a first arm that is coupled to the arm 223 and that rotates around the rotation axis J4 with respect to the arm 223, an arm 225 as a second arm that is coupled to the arm 224 and that rotates around the rotation axis J5 as a first rotation axis with respect to the arm 224 as a second arm, and an arm 226 that is coupled to the arm 225 and that rotates around the rotation axis J6 with respect to the arm 225. An end effector 24 is coupled to the tip end section of the arm 226.

The robot 2 includes a drive mechanism 231 for rotating the arm 221 about the rotation axis J1 with respect to the base 21, a drive mechanism 232 for rotating the arm 222 about the rotation axis J2 with respect to the arm 221, a drive mechanism 233 for rotating the arm 223 about the rotation axis J3 with respect to the arm 222, a drive mechanism 234 for rotating the arm 224 about the rotation axis J4 with respect to the arm 223, a drive mechanism 235 for rotating the arm 225 about the rotation axis J5 with respect to the arm 224, and a drive mechanism 236 for rotating the arm 226 about the rotation axis J6 with respect to the arm 225.

The robot controller 10 independently controls the drive mechanisms 231 to 236, and executes the robot 2 to perform a predetermined task. The robot controller 10 is constituted by, for example, a computer. It includes a processor that processes information, a memory communicably coupled to the processor, and an external interface. Various programs executable by the processor are stored in the memory, and the processor can read and execute the various programs and the like stored in the memory.

The robot system 1 has been briefly described above. However, the configuration of the robot system 1 is not particularly limited. For example, the robot 2 may be a horizontal articulated robot (SCARA robot), a dual-arm robot having two arms, or the like, in addition to the six axes robot. The robot 2 may not be fixed to the floor, and may be fixed to an operatorless carrier such as an Autonomous Mobile Robot (AMR), an Automatic Guided Vehicle (AGV), or the like.

Next, the drive mechanism 235 for rotating the arm 225 around the rotation axis J5 with respect to the arm 224 and the drive mechanism 236 for rotating the arm 226 around the rotation axis J6 with respect to the arm 225 will be described in detail with reference to FIGS. 2 to 4. Hereinafter, for convenience of description, the upper side and the lower side in FIGS. 2 to 4 are also referred to as “upper” and “lower”, respectively.

As shown in FIG. 2, the tip end section of the arm 224 is bifurcated, and the arm 225 is supported from both sides of the rotation axis J5 between the bifurcated portions. The drive mechanism 236 is disposed at an upper tip end section 224a, and the drive mechanism 235 is disposed at a lower tip end section 224b. By supporting the arm 225 at both ends, the rotation accuracy of the arm 225 is improved, and the spaces where the drive mechanism 235 and the drive mechanism 236 are arranged can be separately secured.

The arm 224 includes a housing 31 and a cover 32 attached to the housing 31. A base end section of the housing 31 is rotatably coupled to the arm 223, and a tip end section of the housing 31 is rotatably coupled to the arm 225. A through hole 311, which is coaxial with the rotation axis J5, is formed in the housing 31 at the upper tip end section 224a. The through hole 311 is formed at a position overlapping an input bevel gear unit 5 (to be described later) attached to the arm 225 in a plan view from a direction along the rotation axis J5, and is larger than the input bevel gear unit 5. Therefore, the input bevel gear unit 5 can be removed from the arm 225 via the through hole 311.

A cylindrical first insertion hole 251 along the rotation axis J5 and a cylindrical second insertion hole 252 along the rotation axis J6 are formed in the arm 225. The first insertion hole 251 opens to the tip end section 224a side, and its center axis coincides with the rotation axis J5. The second insertion hole 252 opens to the arm 226 side, and its center axis coincides with the rotation axis J6. The first insertion hole 251 and the second insertion hole 252 connect to each other such that the tip end sections are orthogonal to each other in the arm 225. The input bevel gear unit 5 is inserted into the first insertion hole 251, and an output bevel gear 66 is inserted into the second insertion hole 252. However, the first insertion hole 251 and the second insertion hole 252 are not limited to a cylindrical shape. For example, the plan view may be a polygonal shape such as a quadrangular shape, a hexagonal shape, an elliptical shape, an irregular shape, or the like.

The inside diameter of the first insertion hole 251 decreases in three stages toward the lower side, and includes a base end section 251a, a center section 251b located below the base end section 251a and having a smaller diameter than the base end section 251a, and a tip end section 251c located below the center section 251b and having a smaller diameter than the center section 251b. At the boundary between the base end section 251a and the center section 251b, a placement surface 251d which is constituted by a stepped surface orthogonal to the rotation axis J5 and faces upward is formed. A tapered guide section 251e, whose inside diameter gradually decreases toward the lower side, that is, toward the output bevel gear 66 side, is formed at the boundary between the center section 251b and the tip end section 251c. When the first insertion hole 251 and the second insertion hole 252 have a shape other than a circular shape in plan view, the “diameters” can be rephrased as “widths”.

The drive mechanism 235 includes a motor 41 with a built-in encoder, which is fixed to the housing 31, a decelerator 42, which decelerates the rotation of the motor 41, a pulley 43, which is attached to an output shaft of the motor 41, a pulley 44, which is attached to the decelerator 42, and a power transmission belt 45, which is wound around the pulley 43 and the pulley 44. The decelerator 42 is a harmonic drive gear device, a circular spline 422 is fixed to the housing 31, and a flexspline 423 is fixed to the arm 225. The pulley 44 is fixed to a wave generator 421.

According to such a configuration, the rotation of the motor 41 is transmitted to the wave generator 421 of the decelerator 42 via the pulley 43, the power transmission belt 45, and the pulley 44, and the wave generator 421 rotates. The flexspline 423 rotates at a predetermined reduction gear ratio with respect to the rotation of the wave generator 421 and, as a result, the arm 225 rotates around the rotation axis J5 with respect to the arm 224.

Although the drive mechanism 235 has been described above, the configuration of the drive mechanism 235 is not particularly limited.

The drive mechanism 236 has the input bevel gear unit 5 inserted into the first insertion hole 251 and placed on the placement surface 251d. As shown in FIG. 3, the input bevel gear unit 5 includes a bearing case 51 placed on the placement surface 251d, a bearing 52 accommodated in the bearing case 51 in a preloaded state, and an input bevel gear 53, which is the first gear passing through the bearing case 51 and born by the bearing case 51 via the bearing 52.

The bearing case 51 has a cylindrical shape corresponding to the shape of the first insertion hole 251. The bearing case 51 includes a base body 511 and a lid 512, which is positioned on the upper side of the base body 511 and which is fixed to the base body 511. A housing space for accommodating the bearing 52 and the input bevel gear 53 is formed inside the bearing case 51. However, the shape of the bearing case 51 is not limited to a cylindrical shape. The shape may be determined in accordance with the shape of the first insertion hole 251.

The outer diameter of the base body 511 decreases in three stages toward the lower side and has a base end section 511a, which is a first section, a center section 511b, which is a second section, positioned on the lower side of the base end section 511a and having a smaller diameter than the base end section 511a, and a tip end section 511c positioned on the lower side of the center section 511b and having a smaller diameter than the center section 511b. A mounting surface 511d is formed at the boundary between the base end section 511a and the center section 511b, and is constituted by a stepped surface orthogonal to the rotation axis J5 toward the lower side. A flange 511e projecting into the housing space is formed at the tip end section 511c. The lid 512 is positioned on the upper side of the base body 511 and is fastened and fixed to the base end section 511a using a screw (not shown). The base body 511 and the lid 512 are made of, for example, a metal material such as aluminum or stainless steel.

The above-described bearing case 51 is inserted into the first insertion hole 251 from the base body 511 side, and the mounting surface 511d is placed on the placement surface 251d. This facilitates attachment of the bearing case 51 to the arm 225. At this time, the tip end section 511c of the bearing case 51 is guided to the tip end section 251c by the guide section 251e of the first insertion hole 251 before the mounting surface 511d is placed on the placement surface 251d. Therefore, the bearing case 51 can be easily inserted into the first insertion hole 251. The bearing case 51 is fastened and fixed to the arm 225 by a plurality of screws N in a state of being placed on the placement surface 251d. In a state where the bearing case 51 is fixed to the arm 225, the input bevel gear 53 rotates around the rotation axis J5. The fixing member for fixing the bearing case 51 to the arm 225 is not particularly limited.

The bearing 52 is located in the housing space. In other words, the bearing 52 is housed in the bearing case 51. The bearing 52 includes a first bearing 521 and a second bearing 522. The first bearing 521 and the second bearing 522 are located and spaced apart from each other along the rotation axis J5. By disposing the first bearing 521 and the second bearing 522 such that they are located and spaced apart from each other, the input bevel gear 53 is supported at two points spaced apart from each other, so that the rotation of the input bevel gear 53 is stabilized.

The first bearing 521 is an angular ball bearing. It includes a first outer ring 521a supported by the inner peripheral surface of the base body 511, a first inner ring 521b into which the input bevel gear 53 is inserted, and a ball 521c as a first rolling element located between the first outer ring 521a and the first inner ring 521b. Similarly, the second bearing 522 is an angular ball bearing. It includes a second outer ring 522a supported on the inner peripheral surface of the base body 511, a second inner ring 522b into which the input bevel gear 53 is inserted, and a ball 522c, as the second rolling element disposed between the second outer ring 522a and the second inner ring 522b.

The input bevel gear 53 includes a shaft 531 that passes through the bearing case 51 and that is born by the bearing case 51 via the first bearing 521 and the second bearing 522, and a gear section 532 located at the tip end section of the shaft 531 and on the lower side of the bearing case 51. The gear section 532 is positioned at the tip end section of the first insertion hole 251 and in front of the second insertion hole 252.

The input bevel gear unit 5 further includes a preload mechanism 59 that preloads the first bearing 521 and the second bearing 522. The preload mechanism 59 includes a preload member 54 located between the first bearing 521 and the lid 512 and a preload transmitting member 55 located between the first bearing 521 and the second bearing 522. The preload member 54 is an annular (ring-shaped) spacer shim and is sandwiched between the lid 512 and the first outer ring 521a of the first bearing 521. The preload transmitting member 55 is a cylindrical spacer through which the input bevel gear 53 is inserted and is located between the first inner ring 521b of the first bearing 521 and the second inner ring 522b of the second bearing 522. The second outer ring 522a of the second bearing 522 contacts the flange 511e, so that further displacement is restricted.

The preload member 54 is pressed against the first outer ring 521a by the lid 512 and the first outer ring 521a is pressed downward. The force that the first outer ring 521a receives from the preload member 54 is transmitted from the first inner ring 521b to the second inner ring 522b via the preload transmitting member 55, and presses the second inner ring 522b downward. Thus, the first bearing 521 and the second bearing 522 are uniformly preloaded. The thicker the preload member 54, the larger the pressure applied to the first outer ring 521a, and the larger the preload applied to the first bearing 521 and the second bearing 522. Therefore, by adjusting the thicknesses of the preload member 54, the first bearing 521 and the second bearing 522 can be preloaded with the desired forces. This improves the rotational accuracy and rigidity of the first bearing 521 and the second bearing 522.

A method of adjusting the thickness of the preload member 54 is not particularly limited. For example, the thickness of the preload member 54 may be adjusted by preparing a plurality of preload members 54 having different thicknesses and selecting and using one of the preload members 54. The thickness of the preload member 54 may be adjusted by preparing a plurality of preload members 54 having the same thickness and selecting the number of preload members 54 to be used. According to these methods, the thickness of the preload member 54 can be easily adjusted. The preload member 54 is not limited to the spacer shim, and may be, for example, a wave washer. In this case, the thickness of the preload member 54 can be adjusted by tightening the screw N to elastically deform the wave washer and crush it.

The input bevel gear unit 5 has been described above. As described above, in the present embodiment, the bearing case 51, the bearing 52, the input bevel gear 53, and the preload mechanism 59 are unitized as the input bevel gear unit 5. Therefore, these can be collectively attached to and detached from the arm 225, and the assembly and adjustment of the robot 2 are facilitated. The preloads of the first bearing 521 and the second bearing 522 can be adjusted before being attached to the arm 225, which facilitates the aforementioned task.

The configuration of the input bevel gear unit 5 is not particularly limited. For example, although the bearing case 51 is constituted by the base body 511 and the lid 512, the present disclosure is not limited thereto, and a configuration in which three or more members are coupled may be adopted. Although the base body 511 and the lid 512 are screwed to each other, the method for fixing them is not particularly limited. The number of bearings is not limited to two, and may be three or more. The first bearing 521 and the second bearing 522 may not be angular ball bearings, but may be, for example, angular roller bearings. In the drawings, the first bearing 521 is larger than the second bearing 522, but the present disclosure is not limited thereto, and the first bearing 521 may be smaller than or equal to the second bearing 522.

As shown in FIG. 2, the drive mechanism 236 further includes a motor 61 with a built-in encoder, a pulley 63 attached to an output shaft of the motor 61, a pulley 64 attached to the input bevel gear 53, and a power transmission belt 65 wound around the pulley 63 and the pulley 64. The drive mechanism 236 further includes the output bevel gear 66, which is a second gear connected to the arm 226. The output bevel gear 66 is inserted into the second insertion hole 252. And it includes a shaft 661 born by the arm 225 via a bearing and a gear section 662 that is disposed at the tip end section of the shaft 661 and that meshes with the gear section 532 in the arm 225. The rotation axis of the output bevel gear 66 coincides with the rotation axis J6.

In the drive mechanism 236 having such a configuration, the rotation of the motor 61 is transmitted to the input bevel gear 53 via the pulley 63, the power transmission belt 65, and the pulley 64, and the input bevel gear 53 rotates. The rotation of the input bevel gear 53 is transmitted to the output bevel gear 66, and the arm 226 coupled to the output bevel gear 66 rotates around the rotation axis J6

As shown in FIG. 3, the drive mechanism 236 further includes an adjustment member 7 for adjusting the tooth contact and the backlash between the input bevel gear 53 and the output bevel gear 66. The adjustment member 7 is an annular (ring-shaped) spacer shim and is sandwiched between the placement surface 251d and the mounting surface 511d. The adjustment member 7 adjusts the clearance between the placement surface 251d and the mounting surface 511d along the rotation axis J5. As the thickness of the adjustment member 7 increases, the input bevel gear unit 5 is displaced to the upper side with respect to the arm 225, and the meshing between the input bevel gear 53 and the output bevel gear 66 becomes shallower by that amount. Therefore, by adjusting the thickness of the adjustment member 7, the position of the input bevel gear 53 can be determined, and the tooth contact and the backlash between the input bevel gear 53 and the output bevel gear 66 can be adjusted. As a result, transmission accuracy of the rotational motion can be improved, noise can be reduced, and product life can be extended.

The method of adjusting the thickness of the adjustment member 7 is not limited. For example, a plurality of adjustment members 7 having different thicknesses may be prepared, and one adjustment member 7 may be selected from them. Alternatively, the thickness of the adjustment member 7 may be adjusted by preparing a plurality of adjustment members 7 having the same thickness and selecting the number of adjustment members 7 to be used. According to these methods, the thickness of the adjustment member 7 can be easily adjusted. The adjustment member 7 is not limited to a spacer shim, and may be, for example, a wave washer. In this case, the thickness of the adjustment member 7 can be adjusted by tightening the screws N to elastically deform the wave washer and crush it.

According to the drive mechanism 236 as described above, by changing the thicknesses of the preload member 54, it is possible to adjust only the preloads of the first bearing 521 and the second bearing 522 without causing fluctuation in the tooth contact and the backlash between the input bevel gear 53 and the output bevel gear 66. By adjusting the thickness of the adjustment member 7, it is possible to adjust the tooth contact and the backlash between the input bevel gear 53 and the output bevel gear 66 without causing fluctuation in the preload applied to the first bearing 521 and the second bearing 522. That is, the adjustment of the preload of the first bearing 521 and the second bearing 522 and the adjustment of the tooth contact and the backlash between the input bevel gear 53 and the output bevel gear 66 can be independently performed.

In particular, in the present embodiment, the bearing case 51, the bearing 52, the input bevel gear 53, and the preload mechanism 59 are unitized as an input bevel gear unit 5. Therefore, when adjusting the tooth contact and the backlash between the input bevel gear 53 and the output bevel gear 66, as shown in FIG. 4, the adjustment member 7 can be replaced simply by removing the input bevel gear unit 5 from the arm 225. Even when the input bevel gear unit 5 is removed from the arm 225, the preloads of the first bearing 521 and the second bearing 522 remains constant without being affected by the removal. Therefore, the tooth contact and the backlash between the input bevel gear 53 and the output bevel gear 66 can be adjusted without fluctuating the preload.

As described above, the input bevel gear unit 5 can be removed from the arm 225 via the through hole 311 formed in the housing 31. Therefore, the adjustment member 7 can be replaced while the arm 224 and the arm 225 are connected to each other. Therefore, tooth contact and backlash between the input bevel gear 53 and the output bevel gear 66 can be easily adjusted.

Both of the first bearing 521 and the second bearing 522 are located in the bearing case 51. Therefore, the first bearing 521 and the second bearing 522 are protected by the bearing case 51. Therefore, when adjusting the tooth contact and backlash between the input bevel gear 53 and the output bevel gear 66, even if the input bevel gear unit 5 is repeatedly attached to and detached from the arm 225 to replace the adjustment member 7, the first bearing 521 and the second bearing 522 do not directly collide with the arm 224, the arm 225, and the like, and damage or destruction of the first bearing 521 and the second bearing 522 can be effectively suppressed.

The robot system 1 has been described above. As described above, the robot arm 22 of the robot system 1 includes the arm 225 as the first arm having the first insertion hole 251 and the second insertion hole 252 internally communicating with each other, the bearing case 51 inserted into the first insertion hole 251, the input bevel gear 53 as the first gear passed through the bearing case 51 and inserted into the first insertion hole 251, the first bearing 521 and the second bearing 522 that are disposed inside the bearing case 51, that support so that the input bevel gear 53 rotates around the rotation axis J5 as the first rotation axis with respect to the arm 225, and that are disposed separated from each other along the rotation axis J5, and the output bevel gear 66 as the second gear that is inserted into the second insertion hole 252 and that meshes with the input bevel gear 53 in the arm 225. According to such a configuration, the first bearing 521 and the second bearing 522 can be protected by the bearing case 51. Therefore, for example, even when the input bevel gear 53 is displaced along the rotation axis J5 in order to adjust the tooth contact and backlash between the input bevel gear 53 and the output bevel gear 66, the first bearing 521 and the second bearing 522 do not directly collide with the arm 224, the arm 225, and the like, and damage and destruction of the first bearing 521 and the second bearing 522 can be effectively suppressed.

As described above, the bearing case 51, the input bevel gear 53, the first bearing 521, and the second bearing 522 are unitized as the input bevel gear unit 5. This makes it easy to attach and detach these components to and from the arm 225. The preloads of the first bearing 521 and the second bearing 522 can be adjusted before being attached to the arm 225, which facilitates the aforementioned task.

As described above, the first insertion hole 251 has the placement surface 251d, and the bearing case 51 is placed on the placement surface 251d. This facilitates attachment of the bearing case 51 to the arm 225.

As described above, the bearing case 51 has the base end section 511a as the first portion, the center section 511b as the second portion, which is positioned on the lower side of the base end section 511a, that is, on the output bevel gear 66 side, and has a width smaller than that of the base end section 511a, and the mounting surface 511d as the stepped surface positioned at the boundary between the base end section 511a and the center section 511b. The mounting surface 511d is placed on the placement surface 251d. This facilitates attachment of the bearing case 51 to the arm 225.

As described above, the robot arm 22 includes the adjustment member 7 that is interposed between the placement surface 251d and the bearing case 51 and that adjusts the clearance between the placement surface 251d and the bearing case 51. As a result, tooth contact and backlash between the input bevel gear 53 and the output bevel gear 66 can be adjusted.

As described above, the robot arm 22 includes the preload mechanism 59, which is housed in the bearing case 51, and preloads the first bearing 521 and the second bearing 522 along the rotation axis J5. By appropriately preloading the first bearing 521 and the second bearing 522 by the preload mechanism 59, the rotational accuracy and rigidity of the first bearing 521 and the second bearing 522 are improved.

As described above, the preload mechanism 59 includes the preload member 54 that preloads the first bearing 521 along the rotation axis J5, and the preload transmitting member 55 that is located between the first bearing 521 and the second bearing 522 and that transmits the force that the first bearing 521 receives from the preload member 54 to the second bearing 522. Thus, the first bearing 521 and the second bearing 522 can be uniformly preloaded.

As described above, the first insertion hole 251 includes the tapered guide section 251e whose inside diameter gradually decreases toward the output bevel gear 66 side and that guides the bearing case 51. This facilitates insertion of the bearing case 51 into the first insertion hole 251.

As described above, the robot arm 22 includes the arm 224 as the second arm, which is rotatably coupled to the arm 225 about the rotation axis J5. The arm 224 has a through hole 311 larger than the bearing case 51 at a position overlapping the bearing case 51 in a plan view along the rotation axis J5. Therefore, the bearing case 51 can be removed from the arm 225 via the through hole 311 while the arm 224 and the arm 225 are coupled to each other. Therefore, tooth contact and backlash between the input bevel gear 53 and the output bevel gear 66 can be easily adjusted.

Although the robot arm according to the present disclosure has been described based on the embodiments shown in the drawings, the disclosure is not limited thereto, and the configuration of each part can be replaced with an arbitrary configuration having the same function. Further, any other component may be added to the present disclosure.

In the embodiment described above, the first gear is the input bevel gear 53, and the second gear is the output bevel gear 66. However, the present disclosure is not limited thereto, and the first gear may be the output bevel gear 66, and the second gear may be the input bevel gear 53. That is, the output bevel gear 66 may be unitized as an output bevel gear unit together with the bearing case, the bearing, and the preload mechanism.

1. A robot arm comprising:
a first arm including a first insertion hole and a second insertion hole that internally communicate with each other;
a bearing case inserted into the first insertion hole;
a first gear passed through the bearing case and inserted into the first insertion hole;
a first bearing and a second bearing that are disposed inside the bearing case, that support so that the first gear rotates around a first rotation axis with respect to the first arm, and that are disposed separated from each other along the first rotation axis; and
a second gear that is inserted into the second insertion hole and that meshes with the first gear in the first arm.

2. The robot arm according to claim 1, wherein
the bearing case, the first gear, the first bearing, and the second bearing are unitized.

3. The robot arm according to claim 1, wherein
the first insertion hole includes a placement surface and
the bearing case is placed on the placement surface.

4. The robot arm according to claim 3, wherein
the bearing case includes
a first portion,
a second portion located closer to the second gear side than the first portion and having a width smaller than that of the first portion, and
a mounting surface, which is a stepped surface located at a boundary portion between the first portion and the second portion, and the mounting surface is placed on the placement surface.

5. The robot arm according to claim 3, further comprising:
an adjustment member that is interposed between the placement surface and the bearing case and that adjusts the clearance between the placement surface and the bearing case.

6. The robot arm according to claim 1, further comprising:
a preload mechanism that is housed in the bearing case and that preloads the first bearing and the second bearing along the first rotation axis.

7. The robot arm according to claim 6, wherein
the preload mechanism includes
a preload member configured to preload the first bearing along the first rotation axis and a preload transmitting member located between the first bearing and the second bearing and configured to transmit a force received by the first bearing from the preload member to the second bearing.

8. The robot arm according to claim 1, wherein
the first insertion hole includes a guide section that gradually decreases in width toward the second gear side and that guides the bearing case.

9. The robot arm according to claim 1, further comprising:
a second arm coupled so as to rotate around the first rotation axis with respect to the first arm, wherein
the second arm includes a through hole larger than the bearing case at a position overlapping with the bearing case in a plan view along the first rotation axis.
